(19) United States
(12) Patent Application Publication
(10) Pub. No.: US 2022/0134938 A1
(43) Pub. Date: May 5, 2022

(54) TIE DOWN ROLLER ASSEMBLY STRAP RETRIEVAL DEVICE

(71) Applicant: Hiromi Higo, Chilliwack (CA)

(72) Inventor: Hiromi Higo, Chilliwack (CA)

(21) Appl. No.: 17/084,580

(22) Filed: Oct. 29, 2020

(51) Int. Cl. B60P 7/08; B65H 18/02

(52) U.S. Cl. CPC B60P 7/0846; B65H 18/026; B65H 2402/412; B65H 2402/33; B65H 2402/351

(57) ABSTRACT

A tie down strap retrieval device that is configured to retrieve and roll a tie down strap after use on a flatbed style trailer. The present invention is configured to be releasably secured to a portion of the trailer. The tie down strap retrieval device includes a main support beam wherein the main support beam includes a rail engagement member that is configured to be releasably secured to a section of a trailer. The rail engagement member includes a hook member having a curved section configured to engage a rail or similar element. A roller assembly is rotatably mounted to a first side of the main support beam and includes a support plate and four mounting rods extending outward from the support plate and main support beam. A guide member is proximate the roller assembly and is configured to direct a strap onto the roller assembly.

### FIELD OF THE INVENTION

The present invention relates generally to trucking accessories, more specifically but not by way of limitation, a device configured to assist in the retrieval and storage of large nylon tie down straps that are commonly utilized on commercial tractor trailers.

### BACKGROUND

Millions of commercial tractor trailers traverse the roadways everyday delivering goods to various businesses. These large tractor trailers have significant capacities and have two common types of trailers wherein one is a box style trailer that is fully enclosed and the other is a flatbed style trailer. The flatbed style trailer is utilized to carry various different items that either can't be loaded into a box trailer or perhaps have a slightly greater length and or size. Items such as steel construction beams and logged trees are just a few examples of load types that are carried on flatbed trailers.

Operators of the tractor-trailers are required to secure the cargo load to comply with roadway safety regulations. The most common technique of securing cargo is to utilize nylon straps. These nylon straps are often several inches wide and are capable of withstanding high stress loads. Many flatbed trailers will have devices to hang the straps but after deployment once the cargo is unloaded retrieval of the straps is quite cumbersome. Depending upon the load, the operator of the tractor-trailer having the flatbed style trailer may have to retrieve and store up to a dozen nylon straps.

It is intended within the scope of the present invention to provide a tie down strap retrieval device that can be releasably secured to a side rail of a flatbed style trailer wherein the device of the present invention

### SUMMARY OF THE INVENTION

It is the object of the present invention to provide a tie down strap retrieval device configured to provide rapid retrieval of nylon tie down straps wherein the present invention includes a main support member.

Another object of the present invention is to provide a tie down strap retrieval device configured to be releasably secured to a flatbed style trailer wherein the device further includes a rail engagement member.

A further object of the present invention is to provide a tie down strap retrieval device configured to provide rapid retrieval of nylon tie down straps wherein the rail engagement member includes a top plate and a hook member.

Still another object of the present invention is to provide a tie down strap retrieval device configured to be releasably secured to a flatbed style trailer wherein the main support member has a guide member secured thereto and is perpendicular therewith.

An additional object of the present invention is to provide a tie down strap retrieval device configured to provide rapid retrieval of nylon tie down straps that further includes a roller assembly wherein the roller assembly is rotatably coupled to the main support member.

Yet a further object of the present invention is to provide a tie down strap retrieval device configured to be releasably secured to a flatbed style trailer wherein the roller assembly includes a support plate and a plurality of mounting rods secured thereto.

Another object of the present invention is to provide a tie down strap retrieval device configured to provide rapid retrieval of nylon tie down straps wherein the mounting rods are perpendicular to the support plate and extend outward therefrom.

An alternate object of the present invention is to provide a tie down strap retrieval device configured to be releasably secured to a flatbed style trailer wherein the roller assembly is operably coupled to a handle member.

An alternative objective of the present invention is to provide a tie down strap retrieval device configured to provide rapid retrieval of nylon tie down straps wherein the handle member is located on the opposing side of the main support member from the roller assembly.

Another object of the present invention is to provide a tie down strap retrieval device configured to be releasably secured to a flatbed style trailer wherein the rail engagement member is adjustable.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top view of the preferred embodiment of the present invention; and

FIG. 2 is a left side view of the present invention; and

FIG. 3 is a side perspective view of the right side of the present invention.

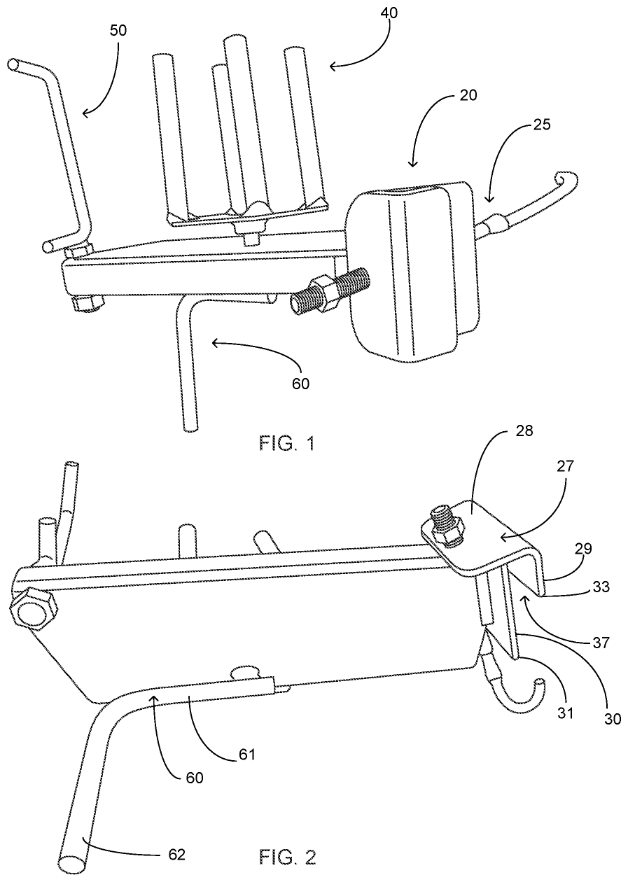

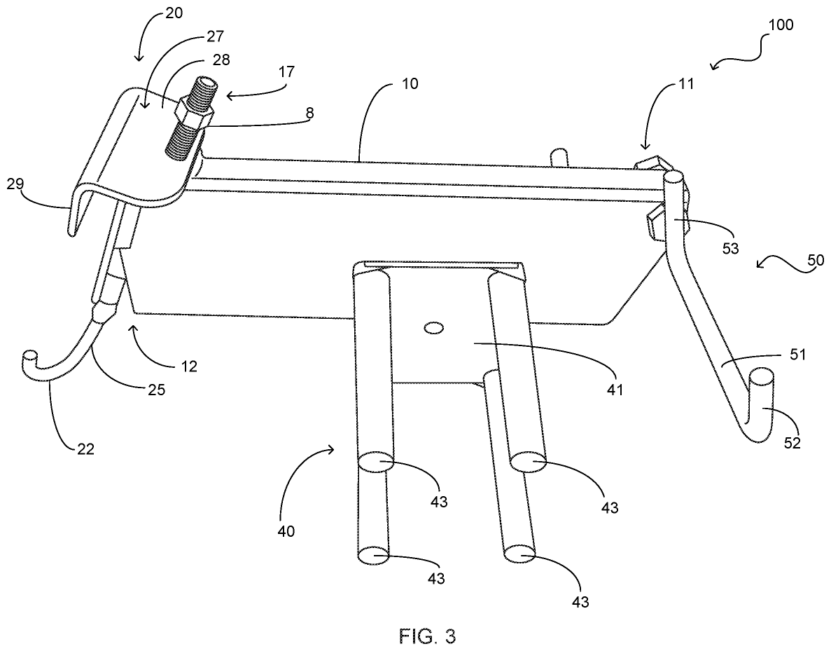

### DETAILED DESCRIPTION

References now to the drawings submitted herewith, wherein various elements depicted therein are not necessarily drawn to scale and wherein through the views and figures like elements are referenced with identical reference numerals, there is illustrated a tie down strap retrieval device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the Drawings submitted as a part hereof, the tie down strap retrieval device 100 includes a main support beam 10. The main support beam 10 is rectangular in shape having a first end 11 and second end 12. The main support beam 10 is manufactured from a durable rigid material such as but not limited to metal. It should be understood within the scope of the present invention that the main support beam 10 could be manufactured in alternate lengths. The main support beam 10 is operably coupled to the rail engagement member 20 at second end 12. The main support beam 10 is secured at an upwards angle with respect to the rail engagement member 20 so as to assist the hook member 25 engage a typical side rail on a flatbed style trailer.

The tie down strap retrieval device 100 includes the rail engagement member 20 that is operable to releasably secure to either a piece of a flatbed trailer or an element that has been secured to a flatbed trailer. The rail engagement member 20 in a preferred use is operably coupled with a rail on a flatbed trailer wherein the top plate 27 is configured to be superposed thereon. The top plate 27 includes a first section 28 and a second section 29 that are contiguously formed. The first section 28 is configured to be parallel and adjacent a portion of a side rail on a flatbed trailer. The second section 29 is perpendicular to the first section 28 and extends downward therefrom. The second section will engage a sidewall portion of a rail and the perpendicular formation of the top plate 27 is to provide the necessary structural support for the main support beam 10 as the main support beam when the tie down strap retrieval device 100 is in use extends outward from the flatbed trailer.

The rail engagement member 20 further includes an inner support plate 30. The inner support plate 30 is parallel the second section 29 of the top plate 27 and has void 37 therebetween suitable to accommodate a portion of a rail tor similar element therein. The inner support plate 30 has a lower edge 31 that extends beyond the lower edge 33 of the second section 29. The greater length of the inner support plate 30 facilitates improved engagement with a rail on a flatbed trailer. The second section 29 is formed of a length so as to allow coupling the tie down strap retrieval device 100 with minimal disruption. It should be understood within the scope of the present invention that the inner support plate 30 and second section 29 could be formed in alternate lengths and further have a void 37 therebetween of alternate widths so as to mateably engage rails or other portions of a flatbed trailer having different sizes.

The rail engagement member 20 includes a hook member 25. Hook member 25 extends downward from the top plate 27 and includes curved section 22. The curved section 22 is configured to mateably engage a bottom edge of a rail or other element of a flatbed trailer. The hook member 25 includes a top end 17 that is threaded in order to receive fastener thereon. Ensuing mounting the tie down strap retrieval device 100, the hook member 25 is positioned such that the curved section 22 is engaged with a bottom edge of a suitable support element and the fastener 8 is utilized to secure the tie down strap retrieval device 100 in place.

Rotatably secured to the main support beam 10 is the roller assembly 40. The roller assembly 40 is operable to engage an end of a nylon strap and facilitate the rolling thereof onto the roller assembly 40 in order to provide retrieval of the strap subsequent use thereof. The roller assembly 40 includes a support plate 41 rotatably secured to the main support beam 10 utilizing suitable durable techniques. The support plate 41 has secured thereto a plurality of mounting rods 43. The mounting rods 43 are manufactured from metal or other suitable material and are secured to the support plate 41 utilizing suitable techniques. The mounting rods 43 are configured to have a nylon strap circumferentially secured thereto facilitating the rolling and retrieval of a nylon strap. It should be understood within the scope of the present invention that the mounting rods 43 could be manufactured in alternate lengths and still achieve the desired objective discussed herein. While four mounting rods 43 are illustrated herein in the preferred embodiment, it is contemplated within the scope of the present invention that the roller assembly 40 could employ less or more than four mounting rods 43.

A guide member 50 is secured to the main support beam 10 proximate the first end 11. The guide member 50 functions to direct the strap or similar element being retrieved and wound by the tie down strap retrieval device 100 onto the roller assembly 40. The guide member 50 includes bottom section 51 and two end sections 52,53 located on opposite ends of the bottom section 51. The bottom section 51 is positioned on the main support beam 10 such that the guide member 50 is above the roller assembly 40. Having the guide member 50 located higher than the roller assembly 40 ensures the ability to properly direct strap as the roller assembly 40 begins to accumulate strap. The bottom section 51 and two end sections 52, 53 are contiguously formed with the two end sections 52, 53 being perpendicular to the bottom section 51 so as to provide direction of a strap onto the roller assembly 40. It should be understood that the guide member 50 could be manufactured in alternate widths so as to accommodate straps of various sizes.

The tie down strap retrieval device 100 includes handle member 60. Handle member 60 includes a first portion 61 and a second portion 62 wherein the first portion 61 and second portion 62 are contiguously formed. The handle member 60 is operably coupled to the roller assembly 40 and is configured so as to provide the rotational movement of the roller assembly 40 in order to provide retrieval of a strap. The first portion 61 and second portion 62 are perpendicular to each other with positions the second portion 62 such that a user can engage therewith in order to effect to rotational movement of the handle member 60 and as such the roller assembly 40. It should be understood within the scope of the present invention that the handle member 60 could be formed in alternate shapes and sizes and still achieve the desired objective discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A tie down retrieval device configured to be secured to a portion of a trailer wherein the tie down retrieval device comprises:
a main support beam, said main support beam having a first end and a second end, said main support beam having an upper edge and a bottom edge, said main support beam having a first side and a second side;
a rail engagement member, said rail engagement member being secured to said first end of said main support beam, said rail engagement member configured to releasably secure to a portion of a trailer;
a roller assembly, said roller assembly being rotatably secured to said first side of said main support beam, said roller assembly having a support plate, said support plate of said roller assembly being adjacent to said first side and parallel therewith, said roller assembly further having at least two mounting rods, said at least two mounting rods extending outward from said support plate, said at least two support rods configured to receive a strap thereon.

2. The tie down retrieval device as recited in claim 1, and further including a handle member, said handle member being mounted adjacent said second side of said main support beam, said handle member being operably coupled to said roller assembly.

3. The tie down retrieval device as recited in claim 2, and further including a guide member, said guide member being secured to said main support beam proximate said first end thereof, said guide member being mounted at a position on said main support beam that is above that of the roller assembly.

4. The tie down retrieval device as recited in claim 3, wherein said rail engagement member further includes a hook member, said hook member extending downward from an upper section of said rail engagement member, said hook member having a curved section configured to operably engage a portion of the trailer.

5. The tie down retrieval device as recited in claim 4, wherein said upper section of said rail engagement member includes an inner support plate and a top plate wherein the top plate includes a portion that is parallel to said inner support plate.

6. The tie down retrieval device as recited in claim 5, wherein said inner support plate and the portion of said top plate have a void therebetween operable to receive a section of the trailer.

7. A tie down retrieval device configured to be secured to a portion of a trailer wherein the tie down retrieval device comprises:
a main support beam, said main support beam being rectangular in shape, said main support beam being manufactured from metal, said main support beam having a first end and a second end, said main support beam having an upper edge and a bottom edge, said main support beam having a first side and a second side;
a rail engagement member, said rail engagement member being secured to said first end of said main support beam, said rail engagement member including a top plate, said top plate of said rail engagement member having a first portion and a second portion, said second portion being contiguously formed with said first portion and perpendicular thereto, said second portion extending downward from said first portion, said rail engagement member configured to operably coupled to a portion of the trailer;
a roller assembly, said roller assembly being rotatably secured to said first side of said main support beam, said roller assembly having a support plate, said support plate of said roller assembly being adjacent to said first side and parallel therewith, said roller assembly further having four mounting rods, said four mounting rods extending outward from said support plate, said four support rods configured to receive a strap surroundably mounted thereto;
a handle member, said handle member being mounted adjacent to said second side of said main support beam, said handle member being operably coupled to said roller assembly, said handle member configured to provide rotation of said roller assembly.

8. The tie down retrieval device as recited in claim 7, wherein said rail engagement member further includes a hook member, said hook member having a first end and a second end, said second end of said hook member having a curved portion.

9. The tie down retrieval device as recited in claim 8, and further including a guide member, said guide member being mounted proximate said first end of said main support beam, said guide member being further secured proximate said top edge of said main support beam, said guide member having a bottom section and opposing end sections.

10. The tie down retrieval device as recited in claim 9, wherein said opposing end sections are contiguously formed with said bottom section of said guide member and extend upward therefrom being perpendicular thereto.

11. The tie down retrieval device as recited in claim 10, wherein said handle member includes a first section and a second section, said first section and said second section being contiguously formed and wherein said second section of said handle member is perpendicular to said first section.

12. The tie down retrieval device as recited in claim 11, wherein said rail engagement member further includes an inner support plate, said inner support plate being parallel with said second portion of said top plate.

13. The tie down retrieval device as recited in claim 12, wherein said rail engagement member further includes a void, said void being intermediate said second portion of said top plate and said inner support plate, said void configured to receive a portion of the trailer therein.

14. The tie down retrieval device as recited in claim 13, wherein said inner support plate includes a bottom edge and said second portion of said top plate includes a bottom edge, wherein said bottom edge of said inner support plate is lower than that of said bottom edge of said second portion of said top plate.
